(19) United States
(12) Patent Application Publication
(10) Pub. No.: US 2022/0251318 A1
(43) Pub. Date: Aug. 11, 2022

(54) PHASE CONTRAST FILM AND PRODUCTION METHOD THEREFOR

(71) Applicant: ZEON CORPORATION, Chiyoda-ku, Tokyo (JP)

(72) Inventor: Kyosuke INOUE, Tokyo (JP)

(73) Assignee: ZEON CORPORATION, Chiyoda-ku, Tokyo (JP)

(21) Appl. No.: 17/597,654

(22) PCT Filed: Jul. 2, 2020
(86) PCT No.: PCT/JP2020/026095

§ 371 Date: Jan. 17, 2022

(30) Foreign Application Priority Data
Jul. 31, 2019 (JP) 2019-141795

(51) Int. Cl. C08J 7/02; C08J 5/18; C08G 61/08; G02B 1/04; G02B 5/30; B29D 11/00; B29C 55/02

(52) U.S. Cl. CPC C08J 7/02; C08J 5/18; C08G 61/08; G02B 1/04; G02B 5/3083; C08G 2261/3325; B29C 55/02; C08J 2365/00; C08G 2261/418; C08G 2261/228; B29D 11/00788

(57) ABSTRACT

A phase difference film formed of a resin containing a polymer having crystallizability, wherein: an NZ factor thereof is less than 1.0; and a haze thereof is less than 1.0%.

### TECHNICAL FIELD

The present invention relates to a phase difference film and a method for producing the same.

### BACKGROUND ART

Technologies for producing a film with resins have been proposed (Patent Literatures 1 to 3).

### CITATION LIST

### Patent Literature

Patent Literature 1: Japanese Patent Application Laid-Open No. Hei. 02-64141 A
Patent Literature 2: Japanese Patent Application Laid-Open No. 2016-26909 A
Patent Literature 3: International Publication No. 2017/065222

### SUMMARY OF THE INVENTION

### Technical Problem

One of the films produced with resins is a phase difference film. Since a phase difference film has a retardation in at least one of the in-plane direction and the thickness direction, a general requirement is to have a high birefringence in at least one of the in-plane direction and the thickness direction.

A balance between a birefringence in the in-plane direction and a birefringence in the thickness direction can be expressed by an NZ factor. For example, when a phase difference film having an NZ factor of less than 1.0 can be obtained, the phase difference film can improve display qualities, such as viewing angle, contrast, and image quality of an display device.

A method for producing a phase difference film having an NZ factor of less than 1.0 has been known. However, a phase difference film having an NZ factor of less than 1.0 could not be produced by the known production method with ease. For example, in the known production method, stretching and shrinkage of a film needed to be performed in combination, or a film including a plurality of layers each having a precisely adjusted thickness needed to be used. Since these necessities increase the number of control items and steps, the production method tended to be complicated.

Since a phase difference film is a type of optical film, the haze of such a film should be as small as possible. However, for a phase difference film having an NZ factor of less than 1.0 and also having a sufficiently slight haze, production itself by the known technology was difficult. Therefore, there has also been demand for a technology to achieve a phase difference film having an NZ factor of less than 1.0 and a slight haze, regardless of whether or not the production method is simple.

The present invention has been devised in view of the aforementioned problem, and has as its object to provide: a phase difference film having an NZ factor of less than 1.0 and a slight haze; and a method for producing a phase difference film having an NZ factor of less than 1.0 with ease.

### Solution to Problem

The present inventor intensively conducted research for solving the aforementioned problem. As a result, the present inventor has found that a phase difference film having an NZ factor of less than 1.0 can be produced with ease by a method including a first step of preparing an optically isotropic resin film formed of a resin containing a crystallizable polymer and a second step of bringing this resin film into contact with an organic solvent to change a birefringence in the thickness direction. The present inventor has further found that this production method can realize a phase difference film having an NZ factor of less than 1.0 and a slight haze. Based on such knowledge, the present inventor accomplished the present invention.

That is, the present invention includes the following aspects.

<1> A phase difference film formed of a resin containing a polymer having crystallizability, wherein:

an NZ factor thereof is less than 1.0; and

a haze thereof is less than 1.0%.

<2> The phase difference film according to <1>, wherein the NZ factor of the phase difference film is more than 0.0 and less than 1.0.
<3> The phase difference film according to <1> or <2>, comprising an organic solvent.
<4> The phase difference film according to <3>, wherein the organic solvent is a hydrocarbon solvent.
<5> The phase difference film according to any one of <1> to <4>, wherein the polymer having crystallizability contains an alicyclic structure.
<6> The phase difference film according to any one of <1> to <5>, wherein the polymer having crystallizability is a hydrogenated product of a ring-opening polymer of dicyclopentadiene.
<7> A method for producing a phase difference film, comprising:

a first step of preparing an optically isotropic resin film formed of a resin containing a polymer having crystallizability; and

a second step of bringing the resin film into contact with an organic solvent to change a birefringence in a thickness direction.

<8> The method for producing a phase difference film according to <7>, comprising, after the second step, a third step of stretching the resin film.
<9> The method for producing a phase difference film according to <7> or <8>, wherein the organic solvent is a hydrocarbon solvent.
<10> The method for producing a phase difference film according to any one of <7> to <9>, wherein the polymer having crystallizability contains an alicyclic structure.
<11> The method for producing a phase difference film according to any one of claims 7 to 10, wherein the polymer having crystallizability is a hydrogenated product of a ring-opening polymer of dicyclopentadiene.

### Advantageous Effects of Invention

According to the present invention, there can be provided: a phase difference film having an NZ factor of less than 1.0 and a slight haze; and a method for producing a phase difference film having an NZ factor of less than 1.0 with ease.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents.

In the following description, an in-plane retardation Re of a film is a value represented by Re=(nx−ny)×d unless otherwise specified. A birefringence in the in-plane directions of a film is a value represented by (nx−ny) unless otherwise specified, and is therefore represented by Re/d. A thickness-direction retardation Rth of a film is a value represented by Rth=[{(nx+ny)/2}−nz]×d unless otherwise specified. A birefringence in the thickness direction of a film is a value represented by [{(nx+ny)/2}−nz] unless otherwise specified, and is therefore represented by Rth/d. An NZ factor of a film is a value represented by (nx−nz)/(nx−ny) unless otherwise specified. Herein, “nx” represents a refractive index in a direction in which the maximum refractive index is given among directions perpendicular to the thickness direction of the film (in-plane directions). “ny” represents a refractive index in a direction, among the above-mentioned in-plane directions of the film, perpendicular to the direction giving nx. “nz” represents a refractive index in the thickness direction of the film. “d” represents the thickness of the film. The measurement wavelength is 590 nm unless otherwise specified.

In the following description, a material having a positive intrinsic birefringence means a material in which the refractive index in the stretching direction is larger than the refractive index in the direction perpendicular to the stretching direction, unless otherwise specified. A material having a negative intrinsic birefringence means a material in which the refractive index in the stretching direction is smaller than the refractive index in the direction perpendicular to the stretching direction, unless otherwise specified. The value of the intrinsic birefringence may be calculated from a permittivity distribution.

In the following description, a “long-length” film refers to a film with the length that is 5 times or more the width, and preferably a film with the length that is 10 times or more the width, and specifically refers to a film having a length that allows a film to be wound up into a rolled shape for storage or transportation. The upper limit of the length thereof is not particularly limited, and is usually 100,000 times or less the width.

In the following description, a direction of an element being “parallel”, “perpendicular” or “orthogonal” may allow an error within the range of not impairing the advantageous effects of the present invention, for example, within a range of ±5°, unless otherwise specified.

In the following description, the lengthwise direction of the long-length film is usually parallel to a film conveyance direction in the production line. Further, an MD direction (machine direction) is a film conveyance direction in the production line, and is usually parallel to the lengthwise direction of the long-length film. Furthermore, a TD direction (transverse direction) is a direction parallel to the film surface and perpendicular to the MD direction, and is usually parallel to the width direction of the long-length film.

<1. Summary of Phase Difference Film According to First Embodiment>

The phase difference film according to the first embodiment of the present invention is formed of a resin containing a crystallizable polymer, and has an NZ factor of less than 1.0 and a slight haze. Such a phase difference film could not be achieved by a prior-art technology, but could be achieved by the present invention for the first time. When this phase difference film is installed in a display device, for example, the phase difference film can improve display qualities such as viewing angle, contrast, and image quality while enhancing the sharpness of an image displayed on the display device.

There has been demand for a technical measure for meeting the challenge of improving display quality while also enhancing the sharpness of an image displayed on a display device. However, it has been difficult to concretize the technical measure. In an aspect, it can be said that the phase difference film according to the first embodiment is the first concretization of the aforementioned technical measure.

<2. Crystallizable Resin Contained in Phase Difference Film>

The phase difference film according to the first embodiment is formed of a resin containing a polymer having crystallizability. The “polymer having crystallizability” represents a polymer having a melting point Tm. In other words, the “polymer having crystallizability” represents a polymer of which the melting point can be observed by a differential scanning calorimeter (DSC). In the following description, a polymer having crystallizability may be referred to as a “crystallizable polymer”. In addition, a resin containing a crystallizable polymer may be referred to as a “crystallizable resin”. This crystallizable resin is preferably a thermoplastic resin.

The crystallizable polymer preferably has a positive intrinsic birefringence. By using a crystallizable polymer with a positive intrinsic birefringence, a phase difference film having an NZ factor of less than 1.0 can be produced with ease.

It is preferable that the crystallizable polymer contains an alicyclic structure. By using a crystallizable polymer containing an alicyclic structure, mechanical properties, heat resistance, transparency, low hygroscopicity, size stability, and light-weight properties of the phase difference film can be improved. A polymer containing an alicyclic structure represents a polymer having an alicyclic structure in a molecule. Such a polymer containing an alicyclic structure may be, for example, a polymer which can be obtained by a polymerization reaction using a cyclic olefin as a monomer or a hydrogenated product thereof.

Examples of the alicyclic structure may include a cycloalkane structure and a cycloalkene structure. Among these, a cycloalkane structure is preferable because a phase difference film with excellent characteristics such as thermal stability is easily obtained. The number of carbon atoms contained in one alicyclic structure is preferably 4 or more, and more preferably 5 or more, and is preferably 30 or less, more preferably 20 or less, and particularly preferably 15 or less. When the number of carbon atoms contained in one alicyclic structure falls within the aforementioned range, mechanical strength, heat resistance, and moldability are highly balanced.

In the crystallizable polymer containing an alicyclic structure, the ratio of the structural unit having an alicyclic structure relative to all structural units is preferably 30% by weight or more, more preferably 50% by weight or more, and particularly preferably 70% by weight or more. By increasing the ratio of the structural unit having an alicyclic structure as described above, heat resistance can be enhanced. The ratio of the structural unit having an alicyclic structure relative to all structural units may be 100% by weight or less. In addition, in the crystallizable polymer containing an alicyclic structure, the remaining portion other than the structural unit having an alicyclic structure is not particularly limited and may be appropriately selected depending on the intended use.

Examples of the crystallizable polymer containing an alicyclic structure may include the following polymer (α) to polymer (δ). Among these, the polymer (β) is preferable because a phase difference film having excellent heat resistance can be easily obtained.

Polymer (α): a ring-opening polymer of a cyclic olefin monomer having crystallizability

Polymer (β): a hydrogenated product of the polymer (α) having crystallizability

Polymer (γ): an addition polymer of a cyclic olefin monomer having crystallizability Polymer (δ): a hydrogenated product of the polymer (γ) having crystallizability

Specifically, the crystallizable polymer containing an alicyclic structure is preferably a ring-opening polymer of dicyclopentadiene having crystallizability and a hydrogenated product of a ring-opening polymer of dicyclopentadiene having crystallizability. Among these, a hydrogenated product of a ring-opening polymer of dicyclopentadiene having crystallizability is particularly preferable. Herein, the ring-opening polymer of dicyclopentadiene refers to a polymer in which the ratio of the structural unit derived from dicyclopentadiene relative to the all structural units is usually 50% by weight or more, preferably 70% by weight or more, more preferably 90% by weight or more, and still more preferably 100% by weight.

The hydrogenated product of the ring-opening polymer of dicyclopentadiene preferably has a high ratio of the racemo⋅diad. Specifically, the ratio of the racemo⋅diad of the repeating unit in the hydrogenated product of the ring-opening polymer of dicyclopentadiene is preferably 51% or more, more preferably 70% or more, and particularly preferably 85% or more. A high ratio of the racemo⋅diad indicates a high degree of syndiotactic stereoregularity. Therefore, the higher the ratio of the racemo⋅diad is, the higher the melting point of the hydrogenated product of the ring-opening polymer of dicyclopentadiene tends to be. The ratio of the racemo⋅diad may be determined on the basis of ¹³C-NMR spectral analyses as described in the examples below.

The above-mentioned polymer (α) to polymer (δ) may be obtained by the production method disclosed in International Publication No. 2018/062067.

The melting point Tm of the crystallizable polymer is preferably 200° C. or higher, and more preferably 230° C. or higher, and is preferably 290° C. or lower. By using a crystallizable polymer having such a melting point Tm, it is possible to obtain a phase difference film with moldability and heat resistance which are furthermore balanced well.

Usually, the crystallizable polymer has a glass transition temperature Tg. The specific glass transition temperature Tg of the crystallizable polymer is not particularly limited, and is usually 85° C. or higher and usually 170° C. or lower.

The glass transition temperature Tg and the melting point Tm of the polymer can be measured by the following method. First, the polymer is melted by heating and the melted polymer is quickly cooled with dry ice. Subsequently, this polymer is used as a test material, and the glass transition temperature Tg and melting point Tm of the polymer may be measured using a differential scanning calorimeter (DSC) at a temperature increasing rate (temperature increasing mode) of 10° C./min.

The weight-average molecular weight (Mw) of the crystallizable polymer is preferably 1,000 or more, and more preferably 2,000 or more, and is preferably 1,000,000 or less, and more preferably 500,000 or less. The crystallizable polymer having such a weight-average molecular weight has moldability and heat resistance which are well balanced.

The molecular weight distribution (Mw/Mn) of the crystallizable polymer is preferably 1.0 or more, and more preferably 1.5 or more, and is preferably 4.0 or less, and more preferably 3.5 or less. Herein, Mn represents a number-average molecular weight. The crystallizable polymer having such a molecular weight distribution has excellent moldability.

The weight-average molecular weight (Mw) and the molecular weight distribution (Mw/Mn) of the polymer may be measured as a polystyrene-equivalent value by gel permeation chromatography (GPC) using tetrahydrofuran as a developing solvent.

The crystallization degree of the crystallizable polymer contained in the phase difference film is not particularly limited, and is usually higher than a certain degree. The specific crystallization degree is preferably 10% or more, more preferably 15% or more, and particularly preferably 30% or more.

The crystallization degree of the crystallizable polymer may be measured by an X-ray diffraction method.

As the crystallizable polymer, one type thereof may be solely used, and two or more types thereof may also be used in combination at any ratio.

The ratio of the crystallizable polymer in the crystallizable resin is preferably 50% by weight or more, more preferably 70% by weight or more, and particularly preferably 90% by weight or more. When the ratio of the crystallizable polymer is equal to or more than the lower limit value of the above-mentioned range, it is possible to enhance developability of the birefringence and heat resistance of the phase difference film. The upper limit of the ratio of the crystallizable polymer may be 100% by weight or less.

The crystallizable resin may include, in addition to the crystallizable polymer, optional components. Examples of the optional components may include an antioxidant such as a phenol-based antioxidant, a phosphorus-based antioxidant, and a sulfur-based antioxidant; a light stabilizer such as a hindered amine-based light stabilizer; a wax such as a petroleum-based wax, a Fischer-Tropsch wax, and a polyalkylene wax; a nucleating agent such as a sorbitol-based compound, a metal salt of an organophosphate, a metal salt of an organocarboxylic acid, kaolin and talc; a fluorescent brightener such as a diaminostilbene derivative, a coumarine derivative, an azole derivative (for example, a benzoxazole derivative, a benzotriazole derivative, a benzimidazole derivative, and a benzothiazole derivative), a carbazole derivative, a pyridine derivative, a naphthalic acid derivative, and an imidazolone derivative; an ultraviolet absorber such as a benzophenone-based ultraviolet absorber, a salicylic acid-based ultraviolet absorber, and a benzotriazole-based ultraviolet absorber; an inorganic filler such as talc, silica, calcium carbonate, and glass fiber; a colorant; a flame retardant; a flame retardant aid; an antistatic agent; a plasticizer; a near infrared absorber; a lubricant; a filler; and an optional polymer other than the crystallizable polymer, such as a soft polymer. As the optional components, one type thereof may be solely used, and two or more types thereof may also be used in combination at any ratio.

<3. NZ Factor of Phase Difference Film>

The NZ factor of the phase difference film according to the first embodiment of the present invention is usually less than 1.0. When the phase difference film having an NZ factor of less than 1.0 is installed in the display device, it is possible to improve display qualities such as viewing angle, contrast, and image qualities, of the display device.

The specific value of the NZ factor of the phase difference film may be set to appropriate values depending on use application of the phase difference film, and may be, for example, less than 0.8, less than 0.6, and less than 0.4. The lower limit of the NZ factor of the phase difference film may be set to appropriate values, and examples thereof may include values more than −1,000, more than −500, more than −100, more than −40, or more than −20. Among these, the NZ factor of the phase difference film is preferably more than 0.0 because it has been particularly difficult to produce the phase difference film by the prior-art technologies.

An NZ factor of a film can be calculated from the in-plane retardation Re and the thickness-direction retardation Rth of the film.

<4. Haze of Phase Difference Film>

The haze of the phase difference film according to the first embodiment of the present invention is usually less than 1.0%, preferably less than 0.8%, more preferably less than 0.5%, and ideally 0.0%. When the phase difference film with a slight haze as described above is installed in a display device, it is possible to enhance sharpness of images displayed on the display device.

A haze of a film may be measured using a haze meter (for example, “NDH5000” manufactured by Nippon Denshoku Industries Co.).

<5. Organic Solvent Contained in Phase Difference Film>

The phase difference film according to the first embodiment of the present invention may contain an organic solvent. This organic solvent is usually incorporated into the film in a second step of the production method described in a second embodiment.

All or a part of the organic solvent incorporated into the film in the second step may enter the interior of the polymer. Therefore, even if the film is dried at or above the boiling point of the organic solvent, it is difficult to completely remove the solvent easily. Therefore, it is normal for the phase difference film to contain an organic solvent.

As the organic solvent described above, those which do not dissolve the crystallizable polymer may be used. Preferable examples of the organic solvents may include a hydrocarbon solvent such as toluene, limonene, and decalin; and carbon disulfide. As the organic solvents, one type thereof may be solely used, and two or more types thereof may also be used.

The ratio (solvent containing rate) of the organic solvent contained in the phase difference film relative to 100% by weight of the phase difference film is preferably 10% by weight or less, more preferably 5% by weight or less, and particularly preferably 0.1% by weight or less.

The solvent containing rate of the phase difference film can be measured by the measuring method described in the Examples.

<6. Other Characteristics of Phase Difference Film>

The phase difference film usually has a large birefringence in at least one of the in-plane directions and the thickness direction. Specifically, the phase difference film usually has at least one of a birefringence Re/d in the in-plane direction of 1.0×10⁻³ or more and an absolute value |Rth/d| of a birefringence in the thickness direction of 1.0×10⁻³ or more.

In particular, the birefringence Re/d in the in-plane direction of the phase difference film is usually 1.0×10⁻³ or more, preferably 3.0×10⁻³ or more, and particularly preferably 5.0×10⁻³ or more. There is no upper limit, and for example, it may be 2.0×10⁻² or less, 1.5×10⁻² or less, or 1.0×10⁻² or less. However, in a case where the absolute value |Rth/d| of the birefringence in the thickness direction of the phase difference film is 1.0×10⁻³ or more, the birefringence Re/d in the in-plane direction of the phase difference film may be out of the range described above.

Furthermore, the absolute value |Rth/d| of the birefringence in the thickness direction of the phase difference film is usually 1.0×10⁻³ or more, preferably 3.0×10⁻³ or more, and particularly preferably 5.0×10⁻³ or more. There is no upper limit, and for example, it may be 2.0×10⁻² or less, 1.5×10⁻² or less, and 1.0×10⁻² or less. However, in a case where the birefringence Re/d in the in-plane direction of the phase difference film is 1.0×10⁻³ or more, the absolute value |Rth/d| of the birefringence in the thickness direction of the phase difference film may be outside of the range described above.

The in-plane retardation Re of the phase difference film may be set to appropriate values according to use application of the phase difference film.

Specifically, the in-plane retardation Re of the phase difference film may be set to, for example, preferably 10 nm or less, more preferably 5 nm or less, and particularly preferably 3 nm or less. In this instance, the phase difference film can serve as a positive C-plate or a negative C-plate.

Furthermore, the specific in-plane retardation Re of the phase difference film may be set to, for example, preferably 100 nm or more, more preferably 110 nm or more, and particularly preferably 120 nm or more, and may be set to preferably 180 nm or less, more preferably 170 nm or less, and particularly preferably 160 nm or less. In this instance, the phase difference film can then serve as a quarter-wave plate.

Still furthermore, the specific in-plane retardation Re of the phase difference film may be set to, for example, preferably 245 nm or more, more preferably 265 nm or more, and particularly preferably 270 nm or more, and may be set to preferably 320 nm or less, more preferably 300 nm or less, and particularly preferably 295 nm or less. In this instance, the phase difference film can then serve as a half-wave plate.

The thickness-direction retardation Rth of the phase difference film may be set to appropriate values according to use application of the phase difference film. Specifically, the thickness-direction retardation Rth of the phase difference film may be set to preferably 200 nm or more, more preferably 250 nm or more, and particularly preferably 300 nm or more. The upper limit thereof may be 10,000 nm or less.

The retardation of the films may be measured using a phase difference meter (for example, “AxoScan OPMF-1” manufactured by AXOMETRICS).

Since the phase difference film is an optical film, the phase difference film preferably has high transparency. Specifically, the total light transmittance of the phase difference film is preferably 80% or more, more preferably 85% or more, and particularly preferably 88% or more. The total light transmittance of the phase difference film may be measured using an ultraviolet-visible spectrometer at wavelengths ranging from 400 nm to 700 nm.

The thickness d of the phase difference film may be set to appropriate values according to use application of the phase difference film. Specifically, the thickness d of the phase difference film is preferably 5 μm or more, more preferably 10 μm or more, and particularly preferably 20 μm or more, and is preferably 200 μm or less, more preferably 100 μm or less, and particularly preferably 50 or less. When the thickness d of the phase difference film is equal to or more than the lower limit value of the above-mentioned range, handling performance can be improved and strength can be increased. When the thickness d of the phase difference film is equal to or less than the upper limit value, winding of a long-length phase difference film is facilitated.

The phase difference film may be a film in a sheet piece shape, and may be a long-length film.

The phase difference film according to the first embodiment described above may be produced by the production method described in the second embodiment, which will be described later.

<7. Summary of Method for Producing Phase Difference Film According to Second Embodiment>

The method for producing a phase difference film according to the second embodiment of the present invention includes: a first step of preparing an optically isotropic resin film formed of a crystallizable resin containing a crystallizable polymer; and a second step of bringing this resin film into contact with an organic solvent to change a birefringence in the thickness direction. In this production method, the NZ factor of the resin film can be adjusted in the second step. Therefore, a phase difference film having an NZ factor of less than 1.0 can be easily produced.

The present inventor assumes that a phase difference film having an NZ factor of less than 1.0 can be obtained by this production method based on the following mechanism. However, the technical scope of the present invention is not limited by the following mechanism.

When the optically isotropic resin film formed of a crystallizable resin is brought into contact with an organic solvent in the second step, the organic solvent infiltrates the resin film. The action of the infiltrating organic solvent induces micro-Brownian motion of the molecules of the crystallizable polymer in the film, and the molecular chains of the film are oriented. According to the study of the present inventor, it is considered that a solvent induced crystallization phenomenon of the crystallizable polymer may proceed during the orientation of the molecular chains.

It is noted that the surface area of the resin film is larger on the front and back surfaces which are major surfaces. Therefore, the infiltration speed of the organic solvent is higher in the thickness direction which extends through the front and back surfaces. Consequently, the aforementioned orientation of the molecules of the crystallizable polymer may proceed such that the molecules of the polymer are oriented in the thickness direction.

This orientation in the thickness direction of the molecules of the crystallizable polymer adjusts the NZ factor of the resin film. Therefore, the resin film after the contact with an organic solvent can be obtained as a phase difference film having an NZ factor of less than 1.0. For facilitating the production of the phase difference film, it is useful that the NZ factor can be adjusted only by bringing the optically isotropic resin film and the organic solvent into contact with each other in this manner.

The method for producing a phase difference film according to the second embodiment of the present invention may further include an optional step in combination with the aforementioned first and second steps. For example, the method for producing a phase difference film may include a third step of stretching the resin film after the second step and a fourth step of subjecting the resin film to a heating treatment after the second step. When these optional steps are performed, there can be obtained a phase difference film as a resin film adjusted in its characteristics by those optional steps.

<8. First Step: Preparation of Resin Film>

In the first step, an optically isotropic resin film formed of a crystallizable resin containing a crystallizable polymer is prepared. In the following description, a resin film, before contact with an organic solvent in the second step, may be appropriately referred to as a “primary film”.

The crystallizable resin as a material of the optically isotropic primary film prepared in the first step may be the same as the crystallizable resin described in the first embodiment. However, the crystallization degree of the crystallizable polymer contained in the primary film is preferably low. The specific crystallization degree is preferably less than 10%, more preferably less than 5%, and particularly preferably less than 3%. When the crystallization degree of the crystallizable polymer contained in the primary film before the contact with the organic solvent is low, many molecules of the crystallizable polymer can be oriented in the thickness direction by the contact with the organic solvent. This enables the adjustment of the NZ factor across a wide range.

The primary film is an optically isotropic resin film. That is, the primary film is a film in which the birefringence Re/d in the in-plane direction is small, and the absolute value |Rth/d| of the birefringence in the thickness direction is small. Specifically, the birefringence Re/d in the in-plane direction of the primary film is usually less than 1.0×10⁻³, preferably less than 0.5×10⁻³, and more preferably less than 0.3×10⁻³. Also, the absolute value |Rth/d| of the birefringence in the thickness direction of the primary film is usually less than 1.0×10⁻³, preferably less than 0.5×10⁻³, and more preferably less than 0.3×10⁻³. Having optical isotropy in this manner indicates that the molecules of the crystallizable polymer contained in the primary film exhibit low degree orientation properties and are in a substantially non-oriented state. When such an optically isotropic resin film is used as the primary film, optical characteristics of the primary film do not need to be precisely controlled, and thus, the orientation properties of the molecules of the crystallizable polymer do not need to be precisely controlled. Therefore, the method for producing a phase difference film can be simplified. Furthermore, when an optically isotropic resin film is used as the primary film, a phase difference film having a slight haze can be usually obtained.

The amount of the organic solvent contained in the primary film is preferably small. More preferably, the primary film does not contain the organic solvent. The ratio (solvent containing rate) of the organic solvent contained in the primary film relative to 100% by weight of the primary film is preferably 1% or less, more preferably 0.5% or less, particularly preferably 0.1% or less, and ideally 0.0%. When the amount of the organic solvent contained in the primary film is low before the contact with the organic solvent, many of the molecules of the crystallizable polymer can be oriented in the thickness direction by contact with the organic solvent. This enables the adjustment of the NZ factor across a wide range.

The solvent containing rate of the primary film may be determined on the basis of the density.

The haze of the primary film is preferably less than 1.0%, preferably less than 0.8%, more preferably less than 0.5%, and ideally 0.0%. The smaller the haze of the primary film is, the more easily the haze of the resulting phase difference film can be made smaller.

The thickness of the primary film is preferably set to appropriate values according to the target thickness of the phase difference film to be produced. The thickness is usually increased by allowing the primary film to be brought into contact with an organic solvent in the second step. On the other hand, when stretching is performed in the third step, the thickness is reduced by the stretching. Therefore, the thickness of the primary film may be set to appropriate values in consideration of the change in thickness in the second and subsequent steps as described above.

The primary film may be a film in a sheet piece shape, but is preferably a long-length film. The use of the long-length primary films allows for the continuous production of phase difference film by a roll-to-roll method, thereby effectively increasing the productivity of phase difference film.

As a method for producing the primary film, a resin molding method such as an injection molding method, an extrusion molding method, a press molding method, an inflation molding method, a blow molding method, a calendar molding method, a cast molding method, or a compression molding method is preferable because the primary film containing no organic solvent is obtained. Among these, an extrusion molding method is preferable because the thickness can be easily controlled.

The production conditions in the extrusion molding method are preferably as follows: The cylinder temperature (molten resin temperature) is preferably Tm or higher, and more preferably “Tm+20° C.” or higher, and is preferably “Tm+100° C.” or lower, and more preferably “Tm+50° C.” or lower. In addition, there is no particular limitation on a cooling body with which the molten resin extruded into a film form is first brought into contact, and a cast roll is usually used. The temperature of this cast roll is preferably “Tg−50° C.” or higher, and preferably “Tg+70° C.” or lower, and more preferably “Tg+40° C.” or lower. Further, the temperature of the cooling roll is preferably “Tg−70° C.” or higher, and more preferably “Tg−50° C.” or higher, and is preferably “Tg+60° C.” or lower, and more preferably “Tg+30° C.” or lower. When a primary film is produced under such conditions, the primary film having a thickness of 1 μm to 1 mm can be easily produced. Herein, “Tm” represents a melting point of a crystallizable polymer, and “Tg” represents a glass transition temperature of a crystallizable polymer.

<9. Second Step: Contact Between Resin Film and Organic Solvent>

In the second step, the resin film as the primary film prepared in the first step is brought into contact with an organic solvent. As the organic solvent, a solvent capable of infiltrating a resin film without causing dissolution of the crystallizable polymer contained in the resin film can be used. Examples thereof may include: a hydrocarbon solvent such as toluene, limonene, and decalin; and carbon disulfide. As the organic solvents, one type thereof may be solely used, and two or more types thereof may also be used.

The contact method for the resin film and the organic solvent is optionally adopted. Examples of the contact method may include: a spraying method whereby the organic solvent is sprayed on the resin film; a coating method whereby the resin film is coated with the organic solvent; and an immersion method whereby the resin film is immersed in the organic solvent. Among these, an immersion method, which facilitates continuous contact, is preferable.

The temperature of the organic solvent to be brought into contact with the resin film is optionally set to temperatures within the range that the organic solvent can be maintained in a liquid state, and therefore may be set to temperatures within the range of not lower than the melting point and not higher than the boiling point of the organic solvent.

The time during which the resin film and the organic solvent are in contact with each other is not particularly specified, but is preferably 0.5 second or longer, more preferably 1.0 second or longer, and particularly preferably 5.0 seconds or longer, and is preferably 120 seconds or shorter, more preferably 80 seconds or shorter, and particularly preferably 60 seconds or shorter. When the contact time is equal to or more than the lower limit value of the aforementioned range, the adjustment of the NZ factor by the contact with the organic solvent can be effectively performed. On the other hand, the varying amount of the NZ factor tends not to significantly change even when the immersion time is lengthened. Therefore, when the contact time is equal to or less than the upper limit value of the aforementioned range, the productivity of the phase difference film can be increased without impairing the qualities of the phase difference film.

The contact with the organic solvent in the second step changes the birefringence Rth/d in the thickness direction of the resin film. This adjusts the NZ factor, and an NZ factor of less than 1.0 can be obtained. The amount of change in the birefringence Rth/d in the thickness direction of the resin film caused by the contact with the organic solvent is preferably 1.0×10⁻³ or more, more preferably 2.0×10⁻³ or more, and particularly preferably 5.0×10⁻³ or more, and is preferably 50.0×10⁻³ or less, more preferably 30.0×10⁻³ or less, and particularly preferably 20.0×10⁻³ or less. The aforementioned amount of change in the birefringence Rth/d in the thickness direction indicates the absolute value of the change in the birefringence Rth/d in the thickness direction.

The birefringence Re/d in the in-plane direction of the resin film may or may not change due to the contact with the organic solvent. From the viewpoint of simplifying the control of the in-plane retardation Re of the phase difference film, the change in the birefringence Re/d in the in-plane direction of the resin film caused by the contact with the organic solvent is preferably small, and it is more preferable that the change does not occur. The amount of change in the birefringence Re/d in the in-plane direction of the resin film caused by the contact with the organic solvent is preferably 0.0×10⁻³ to 2.0×10⁻³, more preferably 0.0×10⁻³ to 1.0×10⁻³, and particularly preferably 0.0×10⁻³ to 0.5×10⁻³. The aforementioned amount of change in the birefringence Re/d in the in-plane direction indicates the absolute value of the change in the birefringence Re/d in the in-plane direction.

When the organic solvent in contact with the resin film infiltrates the resin film, the thickness of the resin film usually increases in the second step. The lower limit of the change rate in the thickness of the resin film at this time may be, for example, 10% or more, 20% or more, or 30% or more. The upper limit of the change rate in the thickness may be, for example, 80% or less, 50% or less, or 40% or less. The aforementioned change rate in the thickness of the resin film is a ratio obtained by dividing the amount of change in the thickness of the resin film by the thickness of the primary film (that is, the resin film before the contact with the organic solvent).

As described above, the birefringence Rth/d in the thickness direction of the resin film changes by the second step. Therefore, when a resin film having desired optical characteristics is obtained by the change in the birefringence Rth/d in the thickness direction in the second step, the resin film can be obtained as a phase difference film.

Also, in the production method according to the second embodiment, an optional step may be further performed to the resin film having been subjected to the second step.

<10. Third Step: Stretching of Resin Film>

The method for producing a phase difference film according to the second embodiment of the present invention may include, after the second step, the third step of stretching the resin film. By the stretching, molecules of the crystallizable polymer contained in the resin film can be oriented in a direction corresponding to the stretching direction. Therefore, with the third step, it is possible to adjust the optical characteristics such as the birefringence Re/d in the in-plane direction, the in-plane retardation Re, the birefringence Rth/d in the thickness direction, the thickness-direction retardation Rth, and the NZ factor of the resin film; and the thickness d of the resin film.

The stretching direction is not particularly limited, and for example, a lengthwise direction, a width direction, an oblique direction, or the like may be mentioned. Herein, the oblique direction represents a direction that is perpendicular to the thickness direction and that is neither perpendicular nor parallel to the width direction. The stretching direction may be a single direction or two or more directions. Thus, examples of the stretching method may include: a uniaxial stretching method such as a method of uniaxially stretching a resin film in the lengthwise direction (longitudinal uniaxial stretching method) and a method of uniaxially stretching a resin film in the width direction (transverse uniaxial stretching method); a biaxial stretching method such as a simultaneous biaxial stretching method in which the resin film is stretched in the width direction while simultaneously stretched in the lengthwise direction, and a successive biaxial stretching method in which the resin film is stretched in one of the lengthwise direction and the width direction and then stretched in the other direction; and a method of stretching a resin film in an oblique direction (oblique stretching method).

The stretching ratio is preferably 1.1 times or more, and more preferably 1.2 times or more, and is preferably 20.0 times or less, more preferably 10.0 times or less, still more preferably 5.0 times or less, and particularly preferably 2.0 times or less. The specific stretching ratio is desirably set to appropriate values in accordance with factors such as optical characteristics, thickness, and strength of the phase difference film to be manufactured. When the stretching ratio is equal to or more than the lower limit value of the above-mentioned range, birefringence can be greatly changed by the stretching. When the stretching ratio is equal to or less than the upper limit value of the above-mentioned range, the direction of the slow axis can be easily controlled, and breakage of the resin film can be effectively suppressed.

The stretching temperature is preferably “Tg+5° C.” or higher, and more preferably “Tg+10° C.” or higher, and is preferably “Tg+100° C.” or lower, and more preferably “Tg+90° C.” or lower. Herein, “Tg” represents a glass transition temperature of a crystallizable polymer. When the stretching temperature is equal to or more than the lower limit value of the above-mentioned range, the resin film can be sufficiently softened to allow uniform stretching. Further, when the stretching temperature is equal to or less than the upper limit value of the above-mentioned range, curing of the resin film due to progress of crystallization of the crystallizable polymer can be suppressed, so that the stretching can be smoothly performed and a large birefringence can be developed by the stretching. Furthermore, it is usually possible to reduce the haze of the obtained resin film to enhance transparency.

By subjecting the resin film to the stretching treatment described above, a stretched film as a stretched resin film can be obtained. As described above, since the birefringence can be changed by the stretching in the third step, the NZ factor can be adjusted. Therefore, in a case where a resin film as a stretched film having desired optical characteristics is obtained by the stretching in the third step, the resin film can be obtained as a phase difference film.

<11. Fourth Step: Heat Treatment of Resin Film>

The method for producing a phase difference film according to the second embodiment of the present invention may include, after the second step, a fourth step of subjecting the resin film to a heat treatment. In a case where the method for producing a phase difference film includes the third step, the fourth step is usually carried out after the third step. By the heat treatment, the crystallization of the crystallizable polymer contained in the resin film can proceed to enhance the orientation of the crystallizable polymer. Furthermore, by the heat treatment, the amount of the organic solvent contained in the resin film can be reduced. Therefore, with the fourth step, the optical characteristics of the resin film can be adjusted.

The heat treatment temperature is usually equal to or higher than the glass transition temperature Tg of the crystallizable polymer and equal to or lower than the melting point Tm of the crystallizable polymer. More specifically, the heat treatment temperature is preferably Tg° C. or higher, and more preferably Tg+10° C. or higher, and is preferably Tm−20° C. or lower, and more preferably Tm−40° C. or lower. In the above-mentioned temperature range, while suppressing the clouding due to the progress of the crystallization, it is possible to rapidly proceed the crystallization of the crystallizable polymer.

The treatment time of the heat treatment is preferably 1 second or longer, and more preferably 5 seconds or longer, and is preferably 30 minutes or shorter, and more preferably 15 minutes or shorter.

As described above, since the birefringence may be changed by the heat treatment in the fourth step, the NZ factor can be adjusted. Therefore, in a case where a resin film having desired optical characteristics is obtained by the heat treatment in the fourth step, the resin film can be obtained as a phase difference film.

<12. Other Steps>

The method for producing a phase difference film may further include optional steps in combination with the steps described above.

The method for producing a phase difference film may include, for example, a step of removing an organic solvent remained on the resin film after the second step. Examples of the method of removing the organic solvent may include drying and wiping.

The method for producing a phase difference film may include, for example, a step of performing a preheat treatment for heating the resin film to a stretching temperature prior to the third step. Usually, the preheating temperature is the same as the stretching temperature, and or may not be the same. The preheating temperature is preferably T1−10° C. or higher, and more preferably T1−5° C. or higher, and is preferably T1+5° C. or lower, and is more preferably T1+2° C. or lower where T1 represents the stretching temperature. The preheating time is freely set and may be preferably 1 second or longer, and more preferably 5 seconds or longer, and may also be preferably 60 seconds or shorter, and more preferably 30 seconds or shorter.

If the method for producing a phase difference film includes the third step or the fourth step, the resin film after those steps may contain residual stress. Therefore, the method for producing a phase difference film may include, for example, a step of performing a relaxation treatment in which the resin film is thermally shrunk to remove the residual stress. In the relaxation treatment, it is generally possible to remove the residual stress by causing thermal shrinkage of the resin film within an appropriate temperature range while maintaining the flatness of the resin film.

According to the production method described above, a long-length primary film can be used to produce a long-length phase difference film. The method for producing a phase difference film may include a step of winding up the long-length phase difference film, thus produced, into a roll shape. Furthermore, a method for producing a phase difference film may include a step of cutting the long-length phase difference film into a desired shape.

<13. Phase Difference Film Produced>

According to the production method of the second embodiment of the present invention described above, since the birefringence can be adjusted with a simple step of bringing the primary film into contact with an organic solvent, a phase difference film having a desired NZ factor can be easily produced. Therefore, according to this production method, it is possible to easily obtain a phase difference film having an NZ factor of less than 1.0.

The NZ factor of the phase difference film produced by the production method according to the second embodiment may be, in particular, the same as the NZ factor of the phase difference film according to the first embodiment. In addition, the phase difference film produced by the production method according to the second embodiment may be the same as the phase difference film according to the first embodiment also in terms of other characteristics in addition to the NZ factor. Therefore, the phase difference film produced by the production method according to the second embodiment may have the same characteristics as those of the phase difference film according to the first embodiment such as the crystallizable resin contained in the phase difference film; the haze of the phase difference film; the amount of the organic solvent contained in the phase difference film; the retardations Re and Rth of the phase difference film; the birefringences Re/d and Rth/d of the phase difference film; the total light transmittance of the phase difference film; and the thickness of the phase difference film.

<14. Use Application>

The phase difference film according to the first embodiment and the phase difference film produced by the production method according to the second embodiment described above may be provided to, for example, a display device. In this case, the phase difference film can have improved display qualities such as the viewing angle, contrast, and quality of an image displayed on the display device.

### EXAMPLE

Hereinafter, the present invention will be specifically described by illustrating Examples. However, the present invention is not limited to the Examples described below. The present invention may be optionally modified for implementation without departing from the scope of claims of the present invention and its equivalents.

In the following description, “%” and “part” representing quantity are on the basis of weight, unless otherwise specified. The operation described below was performed under the conditions of normal temperature and normal pressure, unless otherwise specified.

<Evaluation Method>

(Measurement Method of Weight-Average Molecular Weight Mw and Number-Average Molecular Weight Mn of Polymer)

The weight-average molecular weight Mw and the number-average molecular weight Mn of a polymer were measured as a polystyrene-equivalent value, using a gel permeation chromatography (GPC) system (“HLC-8320” manufactured by Tosoh Corporation). In the measurement, an H type column (manufactured by Tosoh Corporation) was used as a column, and tetrahydrofuran was used as a solvent. The temperature during the measurement was 40° C.

(Measurement Method of Hydrogenation Rate of Polymer)

The hydrogenation rate of the polymer was measured by ¹H-NMR measurement with ortho-dichlorobenzene-d₄ as a solvent, at 145° C.

(Measurement Method of Glass Transition Temperature Tg and Melting Point Tm)

The glass transition temperature Tg and the melting point Tm of a polymer were measured as follows. First, the polymer was melted by heating, and quickly cooled with dry ice. Subsequently, the glass transition temperature Tg and the melting point Tm of this polymer as a test piece were measured using a differential scanning calorimeter (DSC) at a temperature increasing rate (temperature increasing mode) of 10° C./min.

(Measurement Method of Racemo⋅Diad Ratio of Polymer)

The racemo⋅diad ratio of a polymer was measured as follows. The ¹³C-NMR measurement of the polymer was performed with ortho-dichlorobenzene-d⁴ as a solvent, at 200° C., by adopting an inverse-gated decoupling method. In the result of this ¹³C-NMR measurement, a signal at 43.35 ppm attributable to a meso⋅diad and a signal at 43.43 ppm attributable to a racemo⋅diad were identified with a peak at 127.5 ppm of ortho-dichlorobenzene-d⁴ as a reference shift. Based on the intensity ratio of these signals, the racemo⋅diad ratio of the polymer was calculated.

(Measurement Method of Retardations Re and Rth as Well as NZ Factor of Film)

The in-plane retardation Re, thickness-direction retardation Rth, and NZ factor of a film were measured by a phase difference meter (“AxoScan OPMF-1” manufactured by Axometrics Inc.). The measurement wavelength was 590 nm.

(Measurement Method of Thickness of Film)

The thickness of a film was measured using a contact thickness meter (Code No. 543-390 manufactured by Mitutoyo Corporation).

(Measurement Method of Haze of Film)

The haze of a film was measured using a haze meter (“NDH5000” manufactured by Nippon Denshoku Industries Co.).

(Measurement Method of Solvent Containing Rate of Phase Difference Film)

For a primary film (resin film before immersed in a solvent) used for producing the phase difference film as a sample, the weight was measured by thermal gravimetric analysis (TGA: under nitrogen atmosphere, with temperature increasing rate of 10° C./min, at 30° C. to 300° C.). The weight reduction amount ΔWₒ of the primary film at 300° C. was obtained by subtracting the weight Wₒ(300° C.) of the primary film at 300° C. from the weight Wₒ(30° C.) of the primary film at 30° C. Since primary films used in the later-described Examples and Comparative Examples were produced by a melt extrusion method, they do not contain a solvent. Therefore, the weight reduction amount ΔWₒ of this primary film was adopted as a reference in the later-described formula (X).

For a phase difference film as a sample, the weight was measured by thermal gravimetric analysis (TGA: under nitrogen atmosphere, with temperature increasing rate of 10° C./min, at 30° C. to 300° C.) in the same manner as described above. The weight reduction amount ΔW_{R} of the phase difference film at 300° C. was obtained by subtracting the weight W_{R}(300° C.) of the phase difference film at 300° C. from the weight W_{R}(30° C.) of the phase difference film at 30° C.

From the weight reduction amount ΔWₒ of the primary film at 300° C. and the weight reduction amount ΔW_{R} of the phase difference film at 300° C. described above, the solvent containing rate of the phase difference film was calculated according to the following formula (X).

Solvent containing rate (%)={(ΔW_{R}−ΔWₒ)/W_{R}(30° C.)}×100 (X)

### Production Example 1. Production of Crystallizable Resin Containing Hydrogenated Product of Ring-Opening Polymer of Dicyclopentadiene

A metal pressure resistant reaction vessel was sufficiently dried, and thereafter, the inside air therein was substituted with nitrogen. To this metal pressure resistant reaction vessel, 154.5 parts of cyclohexane, 42.8 parts (30 parts as the amount of dicyclopentadiene) of a 70% cyclohexane solution of dicyclopentadiene (endo-isomer containing rate: 99% or more), and 1.9 parts of 1-hexene were added. The mixture was heated to 53° C.

0.014 part of a tetrachlorotungsten phenylimide (tetrahydrofuran) complex was dissolved into 0.70 part of toluene to prepare a solution. Into this solution, 0.061 part of a 19% diethylaluminumethoxide/n-hexane solution was added. The mixture was stirred for 10 minutes to prepare a catalyst solution. This catalyst solution was added into the pressure resistant reaction vessel to initiate a ring-opening polymerization reaction. After that, the reaction was continued at 53° C. for 4 hours to obtain a solution of a ring-opening polymer of dicyclopentadiene. The number-average molecular weight (Mn) and the weight-average molecular weight (Mw) of the obtained ring-opening polymer of dicyclopentadiene were 8,750 and 28,100, respectively, and the molecular weight distribution (Mw/Mn) calculated from the obtained values was 3.21.

Into 200 parts of the obtained solution of the ring-opening polymer of dicyclopentadiene, 0.037 part of 1,2-ethanediol as a terminator was added, heating the mixture to 60° C., and stirring it for 1 hour to terminate the polymerization reaction. Into this solution, 1 part of a hydrotalcite-like compound (“Kyowaad (registered trademark) 2000” manufactured by Kyowa Chemical Industry Co.) was added. The mixture was heated to 60° C. and stirred for 1 hour. After that, 0.4 part of a filter aid (“Radiolite (registered trademark) #1500” manufactured by Showa Chemical Industry Co.) was added, and the absorbent and the solution were filtered off through a PP pleated cartridge filter (“TCP-HX” manufactured by Advantec Toyo Co.).

Into 200 parts (polymer amount: 30 parts) of the filtered solution of the ring-opening polymer of dicyclopentadiene, 100 parts of cyclohexane was added, and 0.0043 part of chlorohydridocarbonyl tris(triphenylphosphine) ruthenium was added. A hydrogenation reaction was performed under a hydrogen pressure of 6 MPa at 180° C. for 4 hours to obtain a reaction liquid containing a hydrogenated product of the ring-opening polymer of dicyclopentadiene. This reaction liquid was a slurry solution with the hydrogenated product precipitated.

The hydrogenated product and the solution contained in the aforementioned reaction liquid were separated using a centrifuge, and dried under reduced pressure at 60° C. for 24 hours to obtain 28.5 parts of the hydrogenated product of the ring-opening polymer of dicyclopentadiene having crystallizability. This hydrogenated product had a hydrogenation rate of 99% or more, a glass transition temperature Tg of 93° C., a melting point (Tm) of 262° C., and a racemo⋅diad ratio of 89%.

To 100 parts of the obtained hydrogenated product of the ring-opening polymer of dicyclopentadiene, 1.1 parts of an antioxidant (tetrakis[methylene-3-(3′,5′-di-t-butyl-4′-hydroxyphenyl)propionate]methane; “Irganox (registered trademark) 1010” manufactured by BASF Japan Co.) was mixed. After that, the mixture was charged into a twin screw extruder (product name “TEM-37B”, manufactured by Toshiba Machine Co.) having four die holes with an inner diameter of 3 mm. The mixture of the hydrogenated product of the ring-opening polymer of dicyclopentadiene and the antioxidant was molded into strands by hot-melt extrusion molding, and thereafter finely cut using a strand cutter to obtain pellets of a crystallizable resin. The operation conditions of the aforementioned twin screw extruder were as follows.
Barrel set temperature=270 to 280° C.
Die set temperature=250° C.
Screw rotation speed=145 rpm

### Example 1

(1-1. First Step: Production of Primary Film)

The crystallizable resin produced in Production Example 1 was molded using a hot-melt extrusion film molder (“Measuring Extruder Type Me-20/2800V3” manufactured by Optical Control Systems Co.) equipped with a T die, and wound up around a roll at a speed of 1.5 m/min to obtain a resin film (thickness: 50 μm) as a long-length primary film having a width of about 120 mm. The operation conditions of the aforementioned film molder were as follows.
Barrel set temperature=280° C. to 300° C.
Die temperature=270° C.
Screw rotation speed=30 rpm
Cast roll temperature=80° C.

(1-2. Second Step: Contact Between Primary Film and Treatment Solvent)

The resin film was cut into a piece with a size of 100 mm×100 mm. The retardation was measured using a phase difference meter and found to be an in-plane retardation Re of 5 nm and a thickness-direction retardation Rth of 6 nm. Since this resin film was produced by hot-melt extrusion at high temperature (280° C. to 300° C.) as described above and thus considered not to contain a solvent, the solvent containing amount was set to 0.0%.

A vat was filled with toluene as a treatment solvent, and the resin film was immersed in this toluene for 5 seconds. After that, the resin film was picked up from toluene, and the surface thereof was wiped off with gauze. The resulting resin film was evaluated by the aforementioned method as a phase difference film. As a result, it was found that the in-plane retardation Re was 9 nm, the thickness-direction retardation Rth was −575 nm, the thickness was 64 and the haze Hz was 0.4%.

### Example 2

In the above-mentioned step (1-1), the thickness of the resin film as a primary film was changed to 20 μm by adjusting the speed (line speed) at which the film was wound up around a roll.

In addition, in the above-mentioned step (1-2), a time for immersing the resin film in a treatment solvent (here, toluene) was changed to 1 second.

Except for these matters, a phase difference film was produced and evaluated by the same manner as that of Example 1.

### Example 3

In the aforementioned step (1-1), the thickness of the resin film as a primary film was changed to 100 μm by adjusting the speed (line speed) at which the film was wound up around a roll.

In addition, in the above-mentioned step (1-2), a time for immersing the resin film in a treatment solvent (here, toluene) was changed to 60 seconds.

Except for these matters, a phase difference film was produced and evaluated by the same manner as that of Example 1.

### Example 4

A stretching apparatus (“SDR-562Z” manufactured by Eto Co.) was prepared. This stretching apparatus was equipped with a clip capable of gripping edges of a rectangular resin film and an oven. Twenty four clips in total were provided: five per edge of a resin film and one per vertex of a resin film. The movement of these clips enabled the stretching of a resin film. Also, two ovens were provided, which could be individually set at a stretching temperature and a heating treatment temperature. Furthermore, the aforementioned stretching apparatus allowed the movement of a resin film from one oven to the other while gripping with the clips.

The production of a resin film as the primary film and the contact of the resin film to toluene were performed by the same method as that of Example 1.

The resin film after the contact with toluene was mounted on the aforementioned stretching apparatus, and the resin film was treated at a preheat temperature of 110° C. for 10 seconds. After that, the resin film was stretched at a stretching temperature of 110° C., a longitudinal stretching ratio of 1 time, a transverse stretching ratio of 1.5 times, and a stretching speed of 1.5 times/10 seconds. The aforementioned “longitudinal stretching ratio” represents a stretching ratio in a direction that coincides with the lengthwise direction of a long-length primary film, and the “transverse stretching ratio” represents a stretching ratio in a direction that coincides with the width direction of a long-length primary film. Accordingly, a stretched film as the resin film having been subjected to a stretching treatment was obtained. This stretched film was evaluated as a phase difference film by the aforementioned method. As a result, it was found that the in-plane retardation Re was 347 nm, the thickness-direction retardation Rth was −12 nm, the thickness was 47 μm, and the haze Hz was 0.4%.

### Example 5

The thickness of the resin film as a primary film was changed to 35 μm by adjusting the speed (line speed) at which the film was wound up around a roll. Except for this matter, a phase difference film was produced and evaluated by the same manner as that of Example 4.

In Example 5, it was found that the thickness of the resin film (resin film before stretching) obtained after the contact with toluene was 47 μm, and the thickness-direction retardation Rth was −420 nm.

### Example 6

At the time of stretching the resin film using the stretching apparatus, the transverse stretching ratio was changed to 1.3 times. Except for this matter, a phase difference film was produced and evaluated by the same manner as that of Example 4.

### Example 7

By the same method as that of Example 4, the production of the resin film as a primary film, contact of the resin film with toluene, and stretching of the resin film were performed.

The stretched film as the resin film having been subjected to the stretching treatment was moved into an oven for heat treatment while being gripped by clips, and the heat treatment was performed at a treatment temperature of 170° C. for 20 seconds. The stretched film after this heat treatment was evaluated in the manner described above as a phase difference film. As a result, it was found that the in-plane retardation Re was 378 nm, the thickness-direction retardation Rth was −10 nm, the thickness was 44 and the haze Hz was 0.4%.

### Example 8

The treatment time in the heat treatment was changed to 10 minutes. Except for this matter, a phase difference film was produced and evaluated by the same manner as that of Example 7.

### Example 9

The thickness of the resin film as a primary film was changed to 30 μm by adjusting the speed (line speed) at which the film was wound up around a roll. At the time of stretching the resin film using the stretching apparatus, the transverse stretching ratio was changed to 1.7 times. Except for these matters, a phase difference film was produced and evaluated by the same manner as that of Example 4.

In Example 9, it was found that the thickness of the resin film (resin film before stretching) obtained after contact with toluene was 41 and the thickness-direction retardation Rth was −370 nm.

### Example 10

The thickness of the resin film as a primary film was changed to 33 μm by adjusting the speed (line speed) at which the film was wound up around a roll. At the time of stretching the resin film using the stretching apparatus, the transverse stretching ratio was changed to 1.4 times. Except for these matters, a phase difference film was produced and evaluated by the same manner as that of Example 4.

In Example 10, it was found that the thickness of the resin film (resin film before stretching) obtained after contact with toluene was 44 μm, and the thickness-direction retardation Rth was −390 nm.

### Example 11

The type of the treatment solvent was changed from toluene to limonene. Except for this matter, a phase difference film was produced and evaluated by the same manner as that of Example 1.

### Example 12

The type of the treatment solvent was changed from toluene to decalin. In addition, the time for immersing the resin film in the treatment solvent (here, decalin) was changed to 60 seconds. Except for these matters, a phase difference film was produced and evaluated by the same manner as that of Example 1.

### Comparative Example 1

A long-length resin film was produced by the same method as that of the step (1-1) of Example 1. The obtained resin film was cut into a piece with a size of 100 mm×100 mm. The cut resin film was attached to the stretching apparatus and treated at a preheating temperature of 110° C. for 10 seconds. After that, the resin film was stretched at a stretching temperature of 110° C. at a longitudinal stretching ratio of 1 time, a transverse stretching ratio of 1.5 times, and a stretching speed of 1.5 times/10 seconds. As a result, it was found that the in-plane retardation Re of the stretched resin film was 62 nm, the thickness-direction retardation Rth was 77 nm, the thickness was 33 μm, and the haze Hz was 0.1%.

The resin film after the stretching as a primary film was brought into contact with toluene as a treatment solvent. That is, a vat was filled with toluene, and the stretched resin film described above was immersed in this toluene for 5 seconds. After that, the resin film was picked up from toluene, and the surface thereof was wiped off with gauze. The resulting resin film was evaluated in the manner described above as a phase difference film.

### Comparative Example 2

A long-length resin film was produced by the same method as that of the step (1-1) of Example 1. The obtained resin film was cut into a piece with a size of 100 mm×100 mm. The cut resin film was attached to the stretching apparatus and treated at a preheating temperature of 110° C. for 10 seconds. After that, the resin film was stretched at a stretching temperature of 110° C. at a longitudinal stretching ratio of 1 time, a transverse stretching ratio of 2 times, and a stretching speed of 1.5 times/10 seconds. As a result, it was found that the in-plane retardation Re of the stretched resin film was 91 nm, the thickness-direction retardation Rth was 85 nm, the thickness was 25 μm, and the haze Hz was 0.1%.

The resin film after the stretching as a primary film was brought into contact with toluene as a treatment solvent. That is, a vat was filled with toluene, and the stretched resin film described above was immersed in this toluene for 5 seconds. After that, the resin film was picked up from toluene, and the surface thereof was wiped off with gauze. The resulting resin film was evaluated in the manner described above as a phase difference film.

### Comparative Example 3

A long-length resin film was produced by the same method as that of the step (1-1) of Example 1. The obtained resin film was cut into a piece with a size of 100 mm×100 mm. A shrink film was bonded onto both surfaces of the cut resin film to obtain a multilayer film. The shrink film had a property of shrinking 20% longitudinally and 25% laterally at 145° C.

The multilayer film was attached to the stretching apparatus and treated at a preheating temperature of 145° C. for 5 seconds. After that, the multilayer film was stretched at a stretching temperature of 145° C. at a longitudinal stretching ratio of 0.8 time and a transverse stretching ratio of 1.2 times. The shrink film was removed from the multilayer film after stretching to obtain a resin film as a phase difference film. This resin film was evaluated by the method described above.

[Results]

The results of the above-mentioned Examples and Comparative Examples are shown in the following tables. In the following tables, used abbreviations represent as follows:

COP: hydrogenated product of ring-opening polymers of dicyclopentadiene

d: thickness

Re: in-plane retardation

Rth: thickness-direction retardation

Hz: haze

TABLE 1
Results of Examples 1 to 8

| | Example 1 | Example 2 | Example 3 | Example 4 | Example 5 | Example 6 | Example 7 | Example 8 |
|---|---|---|---|---|---|---|---|---|
| primary film | | | | | | | | |
| resin | COP | COP | COP | COP | COP | COP | COP | COP |
| thickness d (μm) | 50 | 20 | 100 | 50 | 35 | 50 | 50 | 50 |
| Re (nm) | 5 | 5 | 5 | 5 | 4 | 5 | 5 | 5 |
| Re/d (×10⁻³) | 0.10 | 0.25 | 0.05 | 0.10 | 0.11 | 0.10 | 0.10 | 0.10 |
| Rth (nm) | 6 | 6 | 6 | 6 | 5 | 6 | 6 | 6 |
| Rth/d (×10⁻³) | 0.12 | 0.30 | 0.06 | 0.12 | 0.14 | 0.12 | 0.12 | 0.12 |
| solvent containing rate (%) | 0.0 | 0.0 | 0.0 | 0.0 | 0.0 | 0.0 | 0.0 | 0.0 |
| contact with solvent | | | | | | | | |
| solvent | toluene | toluene | toluene | toluene | toluene | toluene | toluene | toluene |
| contact time (s) | 5 | 1 | 60 | 5 | 5 | 5 | 5 | 5 |
| stretching | | | | | | | | |
| stretching temperature (° C.) | — | — | — | 110 | 110 | 110 | 110 | 110 |
| longitudinal stretching ratio | — | — | — | 1 | 1 | 1 | 1 | 1 |
| transverse stretching ratio | — | — | — | 1.5 | 1.5 | 1.3 | 1.5 | 1.5 |
| heat treatment | | | | | | | | |
| temperature (° C.) | — | — | — | — | — | — | 170 | 170 |
| time (seconds) | — | — | — | — | — | — | 20 | 600 |
| phase difference film | | | | | | | | |
| thickness d (μm) | 64 | 27 | 124 | 47 | 34 | 50 | 44 | 44 |
| Hz (%) | 0.4 | 0.3 | 0.5 | 0.4 | 0.3 | 0.4 | 0.4 | 0.4 |
| Re (nm) | 9 | 5 | 32 | 347 | 250 | 255 | 378 | 378 |
| Re/d (×10⁻³) | 0.14 | 0.19 | 0.26 | 7.38 | 7.35 | 5.10 | 8.59 | 8.59 |
| Rth (nm) | −575 | −294 | −944 | −12 | −9 | −217 | −10 | −10 |
| Rth/d (×10⁻³) | −8.98 | −10.89 | −7.61 | −0.26 | −0.26 | −4.34 | −0.23 | −0.23 |
| NZ factor | −63.39 | −58.30 | −29.00 | 0.47 | 0.46 | −0.35 | 0.47 | 0.47 |
| solvent containing rate(%) | 6.2 | 6.2 | 6.2 | 3.4 | 3.3 | 3.6 | 0.1 or lower | 0.1 or lower |

TABLE 2
Results of Examples 9 to 13 and Comparative Examples 1 to 3

| | | | | | Comparative | Comparative | Comparative |
|---|---|---|---|---|---|---|---|
| | Example 9 | Example 10 | Example 11 | Example 12 | Example 1 | Example 2 | Example 3 |
| primary film | | | | | | | |
| resin | COP | COP | COP | COP | COP | COP | COP |
| thickness d (μm) | 30 | 33 | 50 | 50 | 33 | 25 | 50 |
| Re (nm) | 3 | 3 | 5 | 5 | 62 | 91 | 5 |
| Re/d (×10⁻³) | 0.10 | 0.09 | 0.10 | 0.10 | 1.88 | 3.64 | 0.10 |
| Rth (nm) | 4 | 4 | 6 | 6 | 77 | 85 | 6 |
| Rth/d (×10⁻³) | 0.13 | 0.12 | 0.12 | 0.12 | 2.33 | 3.40 | 0.12 |
| solvent containing rate (%) | 0.0 | 0.0 | 0.0 | 0.0 | 0.0 | 0.0 | 0.0 |
| contact with solvent | | | | | | | |
| solvent | toluene | toluene | limonene | decalin | toluene | toluene | — |
| contact time (s) | 5 | 5 | 5 | 60 | 5 | 5 | — |
| stretching | | | | | | | |
| stretching temperature (° C.) | 110 | 110 | — | — | — | — | 145° C., |
| longitudinal stretching ratio | 1 | 1 | — | — | — | — | 0.8 |
| transverse stretching ratio | 1.7 | 1.4 | — | — | — | — | 1.2 |
| heat treatment | | | | | | | |
| temperature (° C.) | — | — | — | — | — | — | — |
| time (seconds) | — | — | — | — | — | — | — |
| phase difference film | | | | | | | |
| thickness d (μm) | 23 | 30 | 69 | 53 | 40 | 28 | 54 |
| Hz (%) | 0.3 | 0.3 | 0.3 | 0.3 | 6.6 | 4.6 | 0.4 |
| Re (nm) | 245 | 248 | 10 | 5 | 381 | 456 | 10 |
| Re/d (×10⁻³) | 10.65 | 8.27 | 0.14 | 0.09 | 9.53 | 16.29 | 0.19 |
| Rth (nm) | 62 | −64 | −599 | −99 | 135 | 229 | 3 |
| Rth/d (×10⁻³) | 2.67 | −2.13 | −8.68 | −1.87 | 3.38 | 8.18 | 0.06 |
| NZ factor | 0.75 | 0.24 | −59.40 | −19.30 | 0.85 | 1.00 | 0.80 |
| solvent containing rate (%) | 3.3 | 3.2 | 9.1 | 3.9 | 3.3 | 3.1 | 0.1 or lower |

### DISCUSSION

As shown in Comparative Example 3, it was possible to produce a film having an NZ factor of less than 1.0 by a production method that combined stretching and shrinkage of a film. However, the control of stretching and shrinkage in combination was complicated. Furthermore, the film obtained in Comparative Example 3, which has a small birefringence, cannot be used as a phase difference film. Therefore, it is difficult to produce a phase difference film having an NZ factor of less than 1.0 with ease.

Also, as illustrated in Comparative Example 2, a phase difference film having an NZ factor of less than 1.0 could not be produced with ease even when the optically anisotropic primary film was brought into contact with the organic solvent. Furthermore, the phase difference film obtained in Comparative Example 2 has a highly opaque haze, and it is considered that when used in a display device, the sharpness of an image deteriorates.

As illustrated in Comparative Example 1, with a primary film in which the orientation properties of molecules of the crystallizable polymer are adequately controlled by adequately adjusting optical characteristics, a phase difference film having an NZ factor of less than 1.0 can be produced in some cases even when the primary film is optically anisotropic. However, as understood from the result that an NZ factor of less than 1.0 is not obtained in Comparative Example 2 which uses an optically anisotropic primary film as in Comparative Example 1, when an optically anisotropic primary film is used, it is necessary to precisely control the optical characteristics of the primary film in order to achieve an NZ factor of less than 1.0, and thus, it is necessary to precisely control the orientation properties of molecules of the crystallizable polymer contained in the primary film. Therefore, when an optically anisotropic primary film is used, control is complicated, and a phase difference film cannot be produced with ease. Also, the phase difference film according to Comparative Example 1 had a highly opaque haze, in the same manner as the phase difference film according to Comparative Example 2.

In contrast to this, in each of Examples, a phase difference film having an NZ factor of less than 1.0 is obtained by a simple method of bringing the optically isotropic primary film into contact with an organic solvent. Furthermore, all the obtained phase difference films have a haze of sufficiently low opacity. As confirmed from the results of Examples, a phase difference film having an NZ factor of less than 1.0 can be produced with ease by the production method according to the present invention, and the haze of the produced phase difference film can be reduced.

1. A phase difference film formed of a resin containing a polymer having crystallizability, wherein:
an NZ factor thereof is less than 1.0; and
a haze thereof is less than 1.0%.

2. The phase difference film according to claim 1, wherein the NZ factor of the phase difference film is more than 0.0 and less than 1.0.

3. The phase difference film according to claim 1, comprising an organic solvent.

4. The phase difference film according to claim 3, wherein the organic solvent is a hydrocarbon solvent.

5. The phase difference film according to claim 1, wherein the polymer having crystallizability contains an alicyclic structure.

6. The phase difference film according to claim 1, wherein the polymer having crystallizability is a hydrogenated product of a ring-opening polymer of dicyclopentadiene.

7. A method for producing a phase difference film, comprising:
a first step of preparing an optically isotropic resin film formed of a resin containing a polymer having crystallizability; and
a second step of bringing the resin film into contact with an organic solvent to change a birefringence in a thickness direction.

8. The method for producing a phase difference film according to claim 7, comprising, after the second step, a third step of stretching the resin film.

9. The method for producing a phase difference film according to claim 7, wherein the organic solvent is a hydrocarbon solvent.

10. The method for producing a phase difference film according to claim 7, wherein the polymer having crystallizability contains an alicyclic structure.

11. The method for producing a phase difference film according to claim 7, wherein the polymer having crystallizability is a hydrogenated product of a ring-opening polymer of dicyclopentadiene.
